(19) United States
(12) Patent Application Publication
(10) Pub. No.: US 2019/0179272 A1
(43) Pub. Date: Jun. 13, 2019

(54) A method, system, computer program product and computer data-base for controlling an industrial process or machine

(71) Applicant: TripleWin Oy, Espoo (FI)

(72) Inventor: Tom GRÖNSTRAND, Espoo (FI)

(73) Assignee: TripleWin Oy, Espoo (FI)

(21) Appl. No.: 16/322,991

(22) PCT Filed: Aug. 8, 2016
(86) PCT No.: PCT/FI2016/050555

§ 371 Date: Feb. 4, 2019

(51) Int. Cl. G05B 13/04; G05B 19/418

(52) U.S. Cl. CPC G05B 13/048; G05B 19/41885; G05B 19/4183

(57) ABSTRACT

The invention relates to a computerized method, industrial system and a computer program product where the method is utilized for controlling an industrial process or machine. A computer system collects operating data containing a plurality of input variables from an industrial process or machine. The computer system determines from latest measurement results and several preceding measurement results a present state of the industrial process or the machine. The computer system also predicts a future state of the industrial process or the machine from said measurement results. Then the computer system selects at least one input from a subset of inputs having largest effect on the future state of the industrial process or the machine. The computer system controls the selected at least one input variable of the industrial process or the machine for reaching a defined target state of the output of the industrial process or machine.

### FIELD OF THE INVENTION

The invention relates to a method for controlling an industrial process or machine. The invention also relates to a computer system utilized in the control and soft-ware applications saved in the computer system, which implements the method.

### BACKGROUND OF THE INVENTION

Today different kinds of process control systems are used to control industrial processes. An industrial process in this application has been interpreted widely. Some examples of conventional industrial processes are chemical processes, power plants, timber factories and paper and pulp factories where different kinds of machines are utilized. Different kinds of industrial processes where process control systems have also a significant role are means of transport. Some examples of them are boats, airplanes and in the future also self-driving cars. Some industrial process includes also human processes as part of the industrial process in question.

FIG. 1 depicts an example of process output 10 where some kind of control measures is needed to bring the measured variable of the exemplary process output 10 to an acceptable quality level. In FIG. 1 actual measurement values of one process output has been depicted in function of time. In the example a target quality level has been depicted by reference sign 1. Allowable minimum and maximum quality limits of the exemplary process output are depicted by reference signs 2 and 3.

However, the output 10 of the exemplary process is not inside acceptable performance criteria. By reference signs 4, 5 and 6 are depicted three points at different times where the measured value of process output 10 is outside predefined quality limits. In many cases it may be known how the quality defect can be corrected by changing one or more process inputs in a way that is known in that particular process. Needed correcting information may be stored in a historical data-base of the process under study for example. By selecting right corrective measures from the historical data-base the output of the process 10 can be brought inside the quality limits 2 and 3.

However, in many cases the variation of the process output depends on more than one input of the process. In that case at least two inputs to the process are inter-dependent. In some cases it is more difficult to find out and use right corrective actions for bringing the process output back to an acceptable quality level. In many cases also a human operator of the process may be an additional source of information by which the process is tried to bring back to allowable functioning level. In that case quick corrective actions in real-time may not be allowed or possible.

The process control system of applications often uses countless interconnected sensors, controllers, actuators and also operator terminals. The process control systems are developed to help above-mentioned industry processes and means of transport to operate more efficiently and safely. Because many industrial process machines are very complicated systems with a plurality of sensors, controllers, and actuators an automatically functioning control system must be able to facilitate process operations over a wide range of operating conditions in real-time.

Behaviour of a process can be predicted using simulation models in a computer system. A process simulation is a model-based presentation of an industrial process or functioning of a machine. Simulations are performed, usually on a computer-based model of the system, for studying certain system dynamics and characteristics of the process under study. The purpose of any model simulation is to enable its users of the process to draw conclusions about the real system by analysing the received simulation results.

In developing a process control system simulation results may be used to show how the process or machine would work in different operating modes and to find the optimal strategy for giving commands to the process or machine for reaching a target process state.

Most of the industrial processes generate a huge amount of real-time data to be stored and processed efficiently. All measurements, set points, controller outputs, device statuses, motor starts, alarms, operation tracking may be stored into a historical data-base. The historical data-base may be an integral part of a process control system of an industrial process. By means of the collected history data trend charts can be created that show process trends in data over time in different kind of processing situations. Historical data over time increases understanding of the causal-connection between the given control commands and state of the process at some moment.

Either simulation results or data stored on the historical data-base can be utilized in different kind of process optimization systems.

As one example of a process optimization process is so-called multi-variable control loop assessment method and apparatus for analysing, assessing and trouble-shooting control loops in complex industrial processes. A multivariable analysis tool applies an orthogonal decomposition method such as the Partial Least Squares (PLS) to a disturbance model relating to the known loop disturbances to the loop model residue.

The tool first extracts the most dominant correlation to the loop model residue and then uses the residue to search for secondary dominant correlation in an orthogonal space. This process is repeated until no further output variation can be significantly attributed by the next dominant correlation. In this way, the analysis tool is able to estimate the performance potential of each control loop under different disturbance conditions and provide a control performance index by comparing the achieved performance to the performance potential in a multi-variable environment.

This index indicates whether or not a given loop is under optimal operation and shows the variance of the loop from the best achievable loop performance. A problem with PLS (Partial Least Squares Regression) is that the methods is a linear methods. Therefore latent variables are quite abstract and difficult to select proper variables to the process models used.

A process control system is typically executed by utilizing different algorithms, sub-routines or control loops in an industrial process or machine. Some examples of control loops are flow control loops, temperature control loops and pressure con-trot loops. Each control loop may include one or more input blocks, a single-output control block such as a proportional-integral-derivative (PID) or a fuzzy logic control function block, and a single output block, such as an analogue output (AO) function block. These control loops typically perform single-input/single-output control because the control block creates a single control output used to control a single process input. In certain situations, the use of a number of independently operating, single-input/single-output control loops is not very effective because the process variables being controlled are affected by more than a single process input and then in that case each process input may affect the state of many process outputs.

In multiple-input/multiple-output process optimization cases other process control methods are utilized. An example of that is Model Predictive Control (MPC). MPC has become the primary form of advanced multivariable control in the process industry. MPC utilizes a multiple-input/multiple output control strategy in which the effects of changing each of a number of process inputs on each of a number of process outputs is measured and these measured responses are then used to create a control matrix or a model of the process. The process model or control matrix generally defines the steady state operation of the process. The control matrix is as a multiple-input/multiple-output element that is utilized to control the process outputs changes that follow changes made to the process inputs. The changed variables of the outputs are called manipulated variables of the output. Process control actions affecting the manipulated variables of the outputs are carried out by utilizing control variables.

In some cases the number of manipulated variables available within the MPC process the control outputs of the MPC routine is greater than the number of control variables of the process. As a result, there are then more degrees of freedom than are available for optimization and constraint handling.

In this case optimization approach for finding a solution does not always work because some of the MPC controller outputs or predicted controller outputs or some of the manipulated process outputs associated with each of the possible optimized solutions are outside of predefined constraints or limits of the process to be controlled.

In that case the MPC optimizer determines that it cannot find an optimal solution which could keep all of the MPC process control outputs or inputs within previously established constraints or limits. Therefore the MPC optimizer can relax one or more constraints or limits in order to find an acceptable solution. To determine the appropriate number of constraints to drop it may be necessary to perform off-line calculations based on available degrees of freedom within the MPC system. The process of developing an optimal solution by sequentially dropping constraints may need to be repeated until a solution is found, and such an open-ended iterative process is not desirable in most real-time process optimization applications.

One possible solution to the off-line calculation problem in MPC control system is disclosed in US 2004/0049295. The depicted optimization technique, that may be used to optimize an advanced control procedure such as MPC procedure, uses an organized, systematic and computationally simple method of relaxing or redefining different kind of variable constraints or limits when there is no feasible optimal solution within the pre-established constraints or limits to thereby find an achievable optimal solution for use in the MPC control system. The depicted technique is computationally suitable for on-line implementation of a real-time optimizer.

However the solution depicted in US 2004/0049295 and other process control solutions known in the art depict only how to select some input variables to be controlled from a larger group of input variables. They do not give any teachings or guidance how to select from real-time measurement results of the output variables one or more control variables to control those input variables that are known to have the largest effect to the measured process output variable state.

### SUMMARY OF THE INVENTION

An aspect of the invention is a method of operating an industrial process or machine, comprising
obtaining operating data from an operating historical computer data-base, said operating data containing a plurality of input variables collected from an industrial process or machine during operation;
determining, by real time processing on a computer system, by utilizing current measurement results and several preceding measurement results a present state of the industrial process or the machine, and;
predicting by real time processing on the computer system, a state of the industrial process or the machine in a predefined time of the future from said measurement results,
wherein for predicting the said state in the future the computer system determines from said measurement results a subset of input variables from said plurality of input variables as input variables having largest effect on the future state of the industrial process or the machine;
the computer system selects at least one input variable to be controlled, and;
the computer system controls the selected at least one input variable by utilizing at least one control variable of the industrial process or the machine (31) for reaching a target state of the industrial process.

Another aspect of the invention is an industrial system controlling an industrial process or a machine comprising an operating historical computer data-base, the industrial system being configured to:
obtain operating data from the operating historical computer data-base, said operating data containing a plurality of input variables collected from an industrial process or machine during operation,
determine, by real time processing on the computer system, by utilizing current measurement results and several preceding measurement results a present state of the industrial process or the machine,
predict, by real time processing on the computer system, a state of the industrial process or the machine in a predefined time of the future from said measurement results,
wherein to predict the said state in the future by determining from said measurement results a subset of input variables from said plurality of input variables as input variables having largest effect on the future state of the industrial process or the machine,
select at least one input variable to be controlled, and;
control, by utilizing at least one control variable of the industrial process or the machine, the selected at least one input variable for reaching a target state of the industrial process.

Another aspect of the invention is a computer program product comprising:
code means for obtaining operating data from an operating historical computer data-base said operating data containing a plurality of input variables collected from an industrial process or machine during operation;
code means for determining by utilizing current measurement results and several preceding measurement results a present state of the industrial process or the machine;
code means for predicting a state of the industrial process or the machine in a predefined time of the future from said measurement results,
wherein code means for predicting the said state in the future by determining from said measurement results a subset of input variables from said plurality of input variables as input variables having largest effect on the future state of the industrial process or the machine;
code means for selecting at least one input variable to be controlled, and;
code means for controlling the selected at least one input variable by utilizing at least one control variable of the industrial process or the machine for reaching a target state of the industrial process.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows in function of time an example of a process output having two quality limits;

FIG. 2 shows an example where to a process performance has been set a new target state of functioning;

FIG. 3a shows main functional elements of an advantageous embodiment of the invention,

FIG. 3b shows elements to be taken into account when defining in measuring metrics, and;

FIG. 4 shows as an exemplary a flow chart including main functional steps of the method according to the invention.

### DETAILED DESCRIPTION

In the following description, considered embodiments are merely exemplary, and one skilled in the art may find other ways to implement the invention. Although the specification may refer to “an”, “one; or “some” embodiment(s) in several locations, this does not necessarily mean that each such reference is made to the same embodiment(s), or that the feature only applies to a single embodiment or all embodiments. Single feature of different embodiments may also be combined to provide other embodiments.

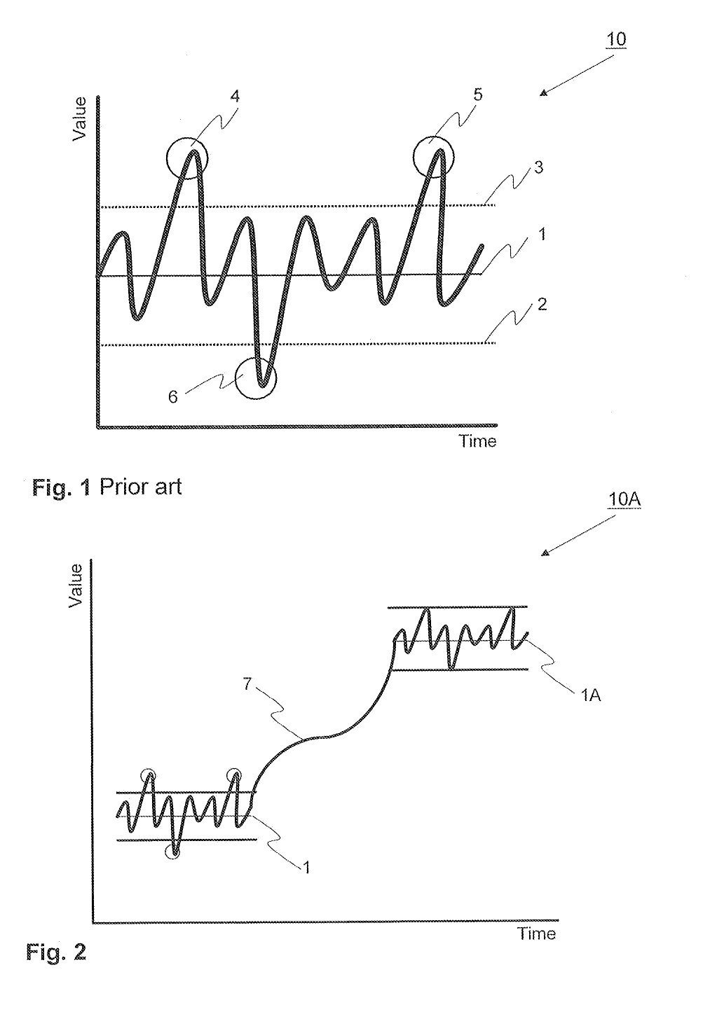

FIG. 1 was discussed in conjunction with the description of the prior art.

FIG. 2 illustrates an example where the present invention can be utilized to shift the output of the process 10A from the original process level 1 to a higher performance level 1A. The shift from the original performance level 1 to higher performance level 1A takes time that depends on the characteristics of the process in question. During the transition from one performance level 1 to another performance level 1A the output of the process is designed to follow a predicted transition curve 7.

In many cases the steepness of the transition curve 7 may be predicted by a so-called logistic function that is also called as sigmoid function:

$$f ( x ) = \frac{L}{1 + {e}^{- k ( x - {x}_{0} )}} \qquad ( 1 )$$

where: e=the natural logarithm base,
x₀=the x-value of the sigmoid's midpoint,
L=the curve's maximum value, and
k=the steepness of the curve.]

Inputs of a process or machine may be different kind and therefore measuring units and measuring scales may vary very much from input to input. Also a timing difference between two consecutive measurements depends on the process or machine characteristics. The timing difference between measurements may vary from fraction of a second to hours or days. That kind of a situation makes it difficult to define a correct measuring scale of an input and also a correct control value for the input that could be utilized to change one or more output of the process or machine in a planned way.

For avoiding the measurement range problem in the method of the present invention all measurement ranges of both inputs and outputs of the process are advantageously normalized to have a pure numerical value that varies between “0” and “1” that are utilized in the process control instead of the actual measurement values and unit of measurements.

Therefore, in the present invention the maximum value “L” of the logistic function (1) is set to “1” for all process outputs. This both simplifies the control process and also hinders one process input to dominate the response of the process or machine when the process or machine is under transition from one performance level to another performance level.

In the method according to the invention normalization of input ranges of process inputs makes it possible to sum up a combined measurement value, called as a combined ratio that can be utilized in a particular measurement moment as a prediction of the output. The combined ratio is calculated as follows. First all input values, which are normalized, are added together. In a second phase the calculated sum of the input values is divided by the number of the utilized inputs. The calculation result depicts the combined ratio of the inputs that can be utilized as a predicted output variable of the process or machine.

When combined ratios are utilized as a control variable then from the calculated combined ratio of the process of the latest measurement moment is first subtracted the combined ratio of the preceding measurement moment. This difference between two consecutive measure moments is defined by a feature Δ. This feature Δ is the first derivative of the combined ratio as a function of time. The first derivative Δ shows the direction where to the controllable process in that particular measurement moment is going to.

The calculated first derivative Δ of the latest measurement moment is then compared to corresponding first derivative Δ of the preceding measurement moment. This difference between two consecutive Δ values is defined by a feature Δ². This feature Δ is the second derivative of the combined ratio as a function of time. The second derivative Δ² shows how fast the process in that particular measurement moment is going either towards a predefined target process state or receding from the transition curve 7.

A predicted value of the output is calculated by comparing the Δ and Δ² values of the latest measurement moment and the Δ and Δ² values of three preceding measurement moments. The predicted output value is then compared against the utilized S curve 7. The detected difference between the utilized S curve 7 and the predicted output value depicts how well the transition process has succeeded from the beginning to the latest measurement moment.

A historical computer data-base of the industrial process or machine advantageously comprises information that depicts which ones of the process or machine inputs have the largest effect on the output at a particular point on the S curve 7. Based on this information and the predicted value of the output it is possible to select at least one input that at that particular moment has the largest corrective effect possibility to the output of the process. To these process inputs are then given new input setting values. The new input settings of the selected inputs can turn the process output towards the S curve 7 of the particular industrial process or machine and in that way also towards to the defined new performance level 1A.

The other process inputs, which are known to have only a limited effect on the output, are given commands where it is expressed that these inputs should stay unchanged and continue with earlier input setting values.

One simple example of the first and second derivative is that if x(t) represents the position of an object at time “t”, the first derivative is the velocity of the object and the second derivative of x(t) is the derivative of x′(t) and it is common general knowledge that the second derivative in this example depicts the object's acceleration. The velocity may depend on several input variables. For example a car velocity may depend on a total mass of the car, tire type, tire pressure, wind direction, temperature of the environment and utilized fuel composition. If the fuel consumption of the car has to be minimized for a trip for example then the selection of the input to be changed by predicted output result depends on the current operation situation of the car.

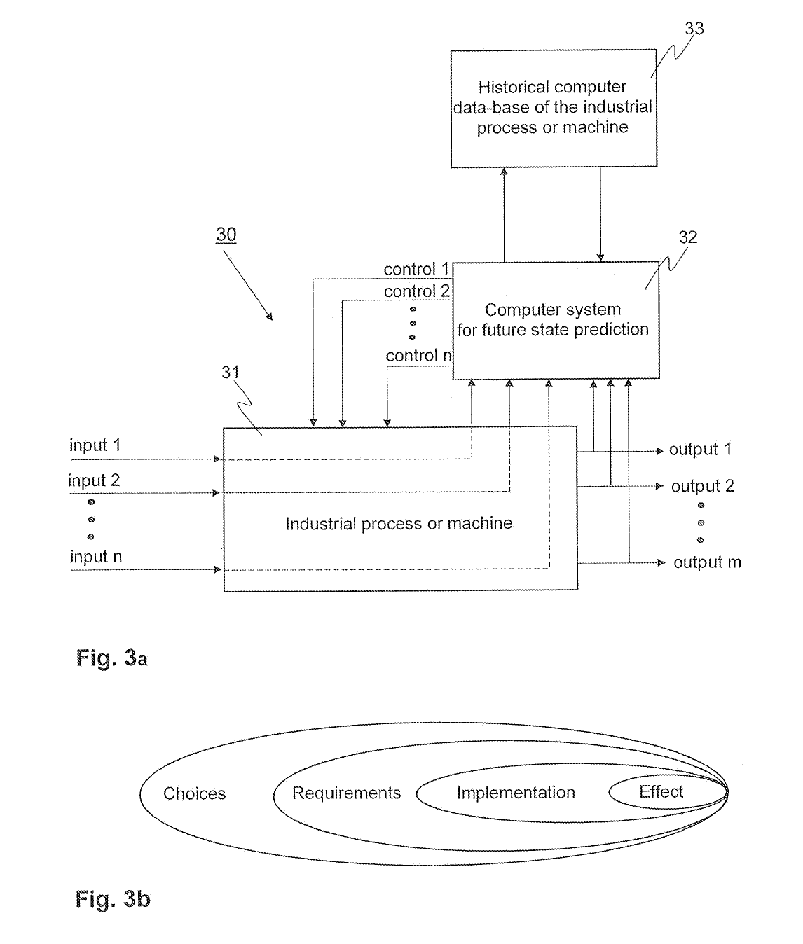

FIG. 3a illustrates an example of a control system of an industrial system 30 or a machine according to the invention. The control system comprises advantageously the industrial process or machine 31, computer system 32 and a connection to a historical computer data-base 33 of the industrial process or machine 31.

The industrial process or machine 31 in the context of the present invention is interpreted in his application widely. An industrial process where the invention is applicable may be for example a chemical process, factory process, energy production plant, property maintenance process, wind turbine, motor, automation system, boat steering process, computer system and a process interface utilized by an operator. The industrial process may comprise also human processes of some kind that are needed to accomplish control steps of the industrial process or machine 31.

The exemplary industrial process or machine 31 of FIG. 3 advantageously comprises several parallel or consecutive technical sub-processes. However, in some cases the industrial process to be controlled may advantageously comprise also decision making actions and control actions accomplished by an operator.

The invention makes also possible to control mainly human processes that have a connection with the computer system 32 of the industrial system 30 that is utilized for predicting a future state of the industrial process or machine 31.

The depicted exemplary industrial process or machine 31 comprises several inputs from “input 1” to “input n”. The inputs may be analog or digital signals by which functioning of the process or machine is controlled. The measuring scales of the inputs may differ and they may also have different units of measurement.

The industrial process or machine 31 comprises advantageously several outputs from “output 1” to “output m”. The outputs may be analog or digital and they depict the state of the industrial process or machine 31 as a function of time. The measuring scales of the outputs may differ and they may have different units of measurement.

The invention may be applied in an industrial process or machine 31 having any number of inputs and outputs. The number of the outputs may be smaller, equal or greater than the number of inputs. In all cases one or more inputs may have an effect on a particular output of the same industrial process or machine 31.

The industrial system 30 comprises also the computer system 32 that is utilized in different calculations that are part of the controlling method according to the invention. The computer system 32 comprises a power source that can be an accumulator or a power source based on mains current. All the electric components of the computer system 32 get their operating voltage from the power source.

The computer system 32 may have one or more processors. The processor or processor means can comprise an arithmetic logic unit, a group of different registers and control circuits. A data storing arrangement, such as a memory unit or memory means, whereon computer-readable information can be stored, has been connected to the processor means. The memory means typically contain memory units, which allow both reading and writing functions (Random Access Memory, RAM), and memory units containing non-volatile memory, from which data can only be read (Read Only Memory, ROM).

Some examples of programs stored in the memory of the computer system 32 are an operating system, converter programs for analog input signals, normalization programs that normalize all input and output signals and a program for predicting future state of the industrial process or machine from the input and output signals of the industrial process or machine 31.

The computer system 32 also advantageously comprises interface elements, which comprise an inputs and means for receiving or sending information. The interface elements of the computer system 32 transfer information either from or to the industrial process or machine 31. The information received with the inputs is transferred to be processed by the processor means of the computer system 32.

The computer system 32 advantageously also comprises a user interface, which comprises means for receiving information from an operator of the industrial process or machine 32.

All inputs and outputs of the industrial process or machine 31 are guided to inputs of the computer system 32 according to the invention. The computer system 32 converts (i.e. normalize) the received input and output signals values to pure number values that advantageously have values between zero and one.

The normalized inputs of the computer system 32 calculate a combined ratio of the inputs that is a prediction of the current state of the process at the latest measurement moment. The calculated ratio is then compared to one or more normalized output values of the industrial process or machine 31.

The comparison results are utilized to define at least one input that have the largest impact to a particular output of the industrial process or machine 31 according to the information of the historical computer data-base 33. By chancing a setting value of that particular input the output state of the industrial process or machine 31 can be guided towards the predicted S curve 7. Each of all inputs has its own control line. In the example of FIG. 3a the control signals bear designations from “control 1” to “control n”.

FIG. 3b illustrates an example how the metrics of the control system of an industrial process or a machine 31 depicted in FIG. 3a are advantageously defined.

Concentrating solely on measuring effects (i.e. outputs of the industrial process or machine) will poorly predict future behavior of the industrial process or machine 31 in question. Only outliers, very good or very bad measurement results, may give some indication about the future behavior of the industrial process or machine 31.

Functioning history of the industrial process or machine 31 is mirrored from the output of the industrial process. The functioning history is advantageously stored in the historical computer data-base 33. Effects stored in the historical computer data-base 33 describe what kind of results has been achieved by previously utilized input settings and control actions. The current metric of the output advantageously also depicts how well the new measurement results are at the measurement moment when they are compared to the predicted S curve 7 that is defined to be utilized during improvement process of the industrial process or machine 31.

When creating a balanced metrics system for the industrial process or machine 31 as a whole, there are advantageously metrics measuring at least the following functional elements: choices, requirements, implementation and effects. This ensures that the usability of the measurement results is as good as possible.

Building of the metrics for the inputs and outputs starts by doing a diagnosis of the most important choices and requirements of the industrial process or machine 31 in question (Choices). In the choices phase most important known future requirements, expectations and strategically relevant matters for the industrial process or machine 30 are defined.

In the next phase (Requirements) it is evaluated if all the requirements and pre-requirements to enable true implementation of the chosen metrics in practice are at hand. The tangible points are selected where most focus is needed when the industrial process or machine is functioning.

In the next phase (Implementation) a connection between implementation operations and effects will be built. Through this the implementation operations and performance is coordinated to achieve the desired output state at some predefined moment in the future. Implementation operations may advantageously be accomplished by using the principles of continuous improvement.

When the metrics of the industrial process or machine 31 has been built as described above, the last thing to do is to further streamline utilized metrics and de-crease or stop utilization of metrics of some inputs and outputs that have been detected to be negligible regarding a particular output state.

Although there may be many metrics during designing, modeling and starting the industrial process or machine 31, but during implementation phase an amount of utilized metrics of the inputs and outputs should be as few as possible. The remaining metrics of inputs should be selected so that they have significant impact to the output state of a particular output of the industrial process or machine 31.

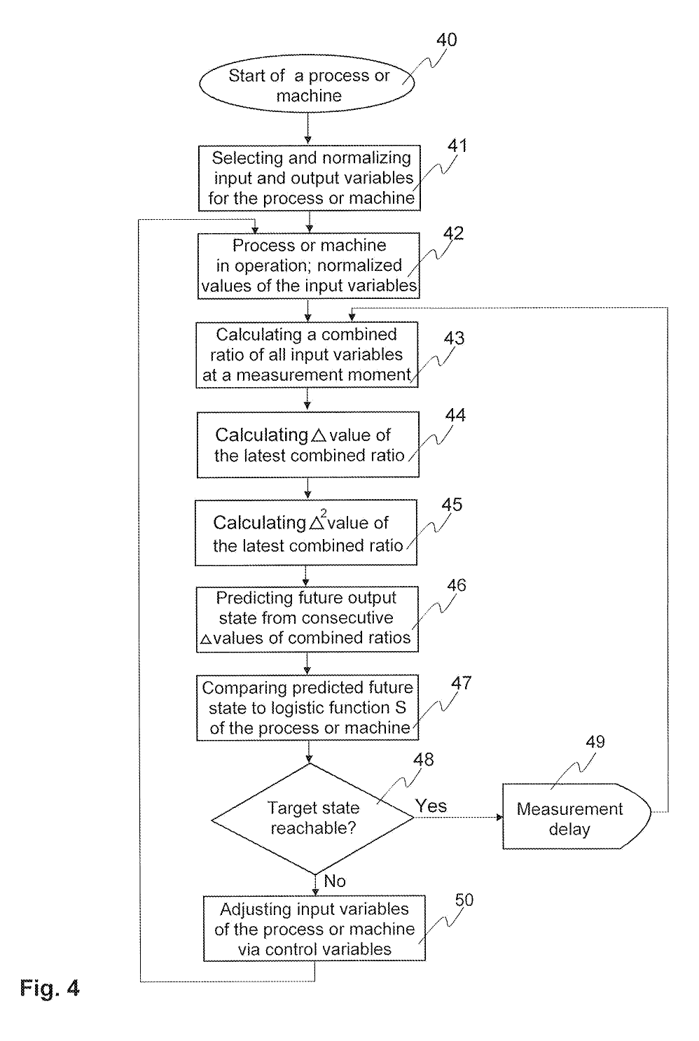

FIG. 4 depicts as an exemplary flow chart the main process steps according to the invention. The process starts from step 40, in which an industrial process or machine has been made ready for functioning and after that started. During the starting step to all inputs have been specified a set point of a predefined value. The starting set point value may be defined by utilizing information available from historical computer data-base 33. The set values of the inputs may be in analog or digital form. The inputs may have the different set values and unit of measurements for controlling the industrial process or machine 31.

In step 40 advantageously also at least to one output has been set a predefined target state, which that particular output should reach after starting of the process.

In step 41 all input and output variables of the industrial process or machine 31 are normalized in the computer system 32 so that any input or output from the industrial process or machine 31 has advantageously a pure numerical value between zero and one.

In step 42 the industrial process or machine 31 is functioning. From time to time depending on the character of the industrial process or machine 31 the actual input and output signals are read to the computer system 32. The read input and output signals are then normalized to have a value between zero and one.

In step 43 the computer system 32 first sums the normalized values of inputs and then divides the sum by the number of utilized inputs. The calculation result is a combined ratio of the inputs at the current measurement moment. The inputs from all inputs that are taken into account in the calculation process may be based on the output to be controlled and/or information read from the historical computer data-base 33 that depicts causal relations between a particular output and several inputs.

In step 44 a difference between the latest combined ratio and the combined ratio of the preceding combined ratio is calculated. The calculation result Δ is a first time derivative of the output to be controlled.

In step 45 the calculation result Δ of the latest measurement moment is advantageously compared to Δ values of three preceding measurement moments. The result Δ² is a second time derivative of the output to be controlled.

In step 46 the computer system 32 calculates a prediction of the state of the output of the industrial process or machine at a particular time in the future by utilizing Δ and Δ² values of the current and three preceding measurement moments.

In step 47 the computer system 32 compares the predicted state against the S curve 7 of that particular output of the industrial process or machine 31.

In step 48 the computer system 32 makes a decision about the predicted output state. The computer system 32 expresses whether the target state defined in step 40 is reachable or not. The decision is based on a difference between the latest prediction result of the output and a value of the S curve point at the measurement moment.

If the difference is inside predefined limits of variation, alternative “Yes”, then in that case the process continues to step 49. Step 49 includes a predefined measurement delay between two consecutive measurements.

From step 49 the control process according to the invention returns back to step 43 where a new measurement and prediction process restarts. The measurement delay step 49 is advantageously industrial process or machine specific. The measurement delay may vary from a fraction of seconds to hours or days.

If the difference in step 48 is outside predefined limits of variation, alternative “No”, then in that case the process continues to step 50.

In step 50 the computer system 32 defines a control signal to at least one input. The defined at least one input that has the largest impact to the output of the industrial process or machine 31 according to the information of the historical computer data-base 33. By chancing a set point of the defined at least one input the output state of the industrial process or machine 31 can be guided towards the utilized S curve 7. Each input of the industrial process or machine 31 advantageously has its own control signal by which a new set point to the input in question advantageously can be set. The new set point of the input is phased in immediately.

From step 50 the control process according to the invention returns back to step 42 where the process now uses inputs where at least one of them has a new set point.

In one advantageous embodiment after returning to step 42 a new measurement is accomplished after a delay that is industrial process or machine specific. The reason for the delay is the knowledge about the inertia of the industrial process or machine 31. A new measurement moment is therefore reasonable when the output of the industrial process or machine has had time to accomplish a reasonable large change in the controlled output. Also in this embodiment the length of the delay is advantageously industrial process or machine specific. Therefore the measurement delay before a new measurement moment may vary from a fraction of seconds to hours or days.

The inventive method may be utilized for example in a chemical process for producing plastic products. Process inputs may be raw materials, temperature settings, pressure and processing time for example. Process outputs to which target states are defined may be quantity of the product, color, hardness, flexibility and gloss for example. The target states of the outputs can be reached by utilization of the method disclosed in FIG. 4.

Another example of utilization of the method according to the invention can be a control system of an ocean-going ship. If for example a mileage of the ship is to be optimized, then at least the following variable circumstances have to be taken into account as inputs of the steering system of the ship. At least the following points have to be taken into account: hull, draught, last on deck, distribution of weight, screw slip, wind direction and wind force, temperature of water and density of water. The ship steering system has to take into account both technical features of the ship and also environmental conditions as inputs to the steering system when optimizing the mileage of the ship from one harbor to another harbor.

Some advantageous embodiments according to the invention were described above. The invention is not limited to the embodiments described. The inventive idea can be applied in numerous ways within the scope defined by the claims attached hereto.

1. A computerized method of controlling an industrial process or a machine, comprising steps of
obtaining operating data from an operating historical computer data-base, said operating data containing a plurality of input variables collected from an industrial process or machine during operation;
determining, by real time processing on a computer system, by utilizing current measurement results and several preceding measurement results a present state of the industrial process or the machine, and;
predicting, by real time processing on the computer system, a state of the industrial process or the machine in a predefined time of the future from said measurement results,
wherein the method further comprises steps, where
for predicting the said state in the future the computer system determines from said measurement results a subset of input variables from said plurality of input variables as input variables having largest effect on the future state of the industrial process or the machine;
the computer system selects at least one input variable to be controlled known having largest effect on the future state of the industrial process or the machine to be controlled and;
the computer system controls the selected at least one input variable by utilizing at least one control variable of the industrial process or the machine for reaching a target state of the industrial process or machine.

2. The computerized method according to claim 1, wherein before determining the present state all measurement results of the input variables have been normalized to have a same numerical range between a minimum and a maximum measured input.

3. The computerized method according to claim 2, wherein in the determination of the future state the computer system utilizes three last measurement results of each utilized input variables.

4. The computerized method according to claim 3, wherein the computer system calculates a first derivative and a second derivative of each input variable by utilizing said three consecutive measurement results of the input variables.

5. The computerized method according to claim 4, wherein the computer system calculates the state of the industrial process or the machine in a predefined time of the future by utilizing said first derivative and said second derivative of said selected input variables.

6. The computerized method according to claim 1, wherein the computer system makes control operations for reaching the target state automatically or under control of a process operator.

7. An industrial system controlling an industrial process or a machine, the industrial system comprising an operating historical computer data-base, the industrial system being configured to
obtain operating data from the operating historical computer data-base, said operating data containing a plurality of input variables collected from an industrial process or machine during operation;
determine, by real time processing on a computer system, by utilizing current measurement results and several preceding measurement results a present state of the industrial process or the machine;
predict, by real time processing on the computer system, a state of the industrial process or the machine in a predefined time of the future from said measurement results,
wherein the industrial system is further configured to
predict the said state in the future by determining from said measurement results a subset of input variables from said plurality of input variables as input variables having largest effect on the future state of the industrial process or the machine,
select at least one input variable to be controlled known having largest effect on the future state of the industrial process or the machine to be controlled, and;
control, by utilizing at least one control variable of the industrial process or the machine, the selected at least one input variable for reaching a target state of the industrial process or machine.

8. The computer system according to claim 7, wherein before determining the present state the computer system is configured to normalize all measurement results of the input variables to have a same numerical range between a minimum and a maximum measured input.

9. The computer system according to claim 8, wherein in the determination of the future state the computer system is configured to utilize three last measurement results of each utilized input variables.

10. The computer system according to claim 9, wherein the computer system is configured to calculate a first derivative and a second derivative of each input variable by utilizing said three consecutive measurement results of the input variables.

11. The computer system according to claim 10, wherein the computer system is configured to predict the state of the industrial process or the machine in a predefined time of the future by utilizing said first derivative and said second derivative of said selected input variables.

12. The computer system according to claim 7, wherein the computer system is configured to make control operations for reaching the target state automatically or under control of a process operator.

13. A computer program product comprising computer program code means adapted to perform the following program code steps when said program is executed on a computer for controlling an industrial process or a machine comprising:
code means for obtaining operating data from an operating historical computer data-base said operating data containing a plurality of input variables collected from an industrial process or machine during operation;
code means for determining by utilizing current measurement results and several preceding measurement results a present state of the industrial process or the machine, and;
code means for predicting a state of the industrial process or the machine in a predefined time of the future from said measurement results,
wherein the computer program product further comprises
code means for predicting the said state in the future by determining from said measurement results a subset of input variables from said plurality of input variables as input variables having largest effect on the future state of the industrial process or the machine;
code means for selecting at least one input variable known having largest effect on the future state of the industrial process or the machine to be controlled, and;
code means for controlling the selected at least one input variable by utilizing at least one control variable of the industrial process or the machine for reaching a target state of the industrial process or machine.

14. The computer program product according to claim 13, wherein before determining the present state all measurement results of the input variables have been normalized to have a same numerical range between a minimum and a maximum measured input.

15. The computer program product according to claim 14, wherein it comprises code means for utilizing in the determination of the future state three last measurement results of each utilized input variables.

16. The computer program product according to claim 15, wherein it comprises code means for calculating a first derivative and a second derivative of each input variable by utilizing said three consecutive measurement results of the input variables.

17. The computer program product according to claim 16, wherein it comprises code means for predicting the state of the industrial process or the machine in a predefined time of the future by utilizing said first derivative and said second derivative of said selected input variables.

18. The computer program product according to claim 13, wherein it comprises code means to make control operations for reaching the target state automatically or under control of a process operator.
